(19) United States
(12) Patent Application Publication
(10) Pub. No.: US 2019/0348033 A1
(43) Pub. Date: Nov. 14, 2019

(54) GENERATING A COMMAND FOR A VOICE ASSISTANT USING VOCAL INPUT

(71) Applicant: FUJITSU LIMITED, Kawasaki-shi (JP)

(72) Inventors: Cong CHEN, Sunnyvale, CA (US); Ajay CHANDER, San Francisco, CA (US); Kanji UCHINO, Santa Clara, CA (US)

(73) Assignee: FUJITSU LIMITED, Kawasaki-shi (JP)

(21) Appl. No.: 15/976,855

(22) Filed: May 10, 2018

(51) Int. Cl. G10L 15/22

(52) U.S. Cl. CPC G10L 15/22; G10L 2015/223

(57) ABSTRACT

A method may include receiving a first vocal input, which may include conversational language describing a portion of a command to be generated for a voice assistant. The method may include determining a structure of the command based on the first vocal input. The method may include generating a template for the command based on the structure. The template may include a particular sequence of segments. The method may include providing a prompt for a second vocal input that includes conversational language. The second vocal input may correspond to at least one segment of the particular sequence. The method may include receiving the second vocal input. The method may include assigning one or more portions of the first and the second vocal input to corresponding segments of the particular sequence. The method may include generating an executable representation of the command, which may include the particular sequence of segments.

### FIELD

The embodiments discussed in the present disclosure are related to generating a command for a voice assistant using vocal input.

### BACKGROUND

A voice assistant may perform a pre-programmed command by receiving input (e.g., user input) and performing speech recognition on the input. The input may be parsed and if the parsing result matches a known response, the voice assistant may perform the command. If the parsing result does not match a known response, the voice assistant may perform a default action such as notifying the user the input is not recognized.

### SUMMARY

According to an aspect of an embodiment, a method may include receiving a first vocal input. The first vocal input may include conversational language describing a portion of a command to be generated for a voice assistant. The method may also include determining a structure of the command based on the first vocal input. The method may additionally include generating a template for the command. The template may be based on the structure. The template may include a particular sequence of segments. The method may include providing a prompt for a second vocal input that includes conversational language. The second vocal input may correspond to at least one segment of the particular sequence. The method may also include receiving the second vocal input. The method may additionally include assigning one or more portions of the first vocal input and the second vocal input to corresponding segments of the particular sequence. The method may include generating an executable representation of the command. The executable representation may include the particular sequence of segments.

The object and advantages of the embodiments will be realized and achieved at least by the elements, features, and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 is a block diagram of an example computing device related to generating a command for a voice assistant using vocal input;

FIG. 2 illustrates an example computing system that may be configured to generate a command using vocal input;

FIG. 3 illustrates a flow diagram of an example method related to generating a command using vocal input;

FIG. 4 illustrates an example logical form of a parsed vocal input, which may be used for generating a command using the vocal input;

FIG. 5 illustrates an example flow diagram of a template, which may be used for generating a command using vocal input;

FIG. 6 illustrates a flow diagram of an example operation of a previously generated command using vocal input; and

FIG. 7 illustrates a flow diagram of an example method related to generating a command using vocal input.

### DESCRIPTION OF EMBODIMENTS

Voice assistants may receive input (e.g., text input and/or vocal input) from a user. The vocal input may include conversational language (e.g., natural language). The vocal input may include language indicating a command, task, program, function, etc. (herein commands) to be performed by the virtual assistant. Typically, voice assistants only support pre-programmed commands created by professional developers (e.g., people who are familiar with programming languages, computer programming, etc.). The professional developers may create these commands using application programming interfaces (API) or software development kits (SDKs) geared towards the professional developers. Thus, voice assistants typically only perform commands and generate responses based on the input as specified by the professional developers. Typically, end-users (e.g., a user) are not able to generate new commands for the voice assistant.

For example, a voice assistant may receive a voice command from a user. The voice assistant may perform speech recognition by converting the voice command to text. The voice assistant may create a tokenized request to send to a user program (e.g., the text may be mapped to functions included in a professionally developed command and/or program). The voice assistant may receive a tokenized response user program (e.g., user program output) instructing the voice assistant to perform a particular function corresponding to the voice command. The voice assistant may perform the function and may provide a response to the user and may not allow the user to generate new commands for the voice assistant to perform.

Accordingly, embodiments described in the present disclosure are directed to methods and systems that permit a user to generate a new command for a voice assistant using vocal input that includes conversational language. The command may include a combination of existing functions (e.g., functions that are already supported by the voice assistant). In some embodiments, a voice assistant may include a program composer, a function library module, and/or a program executor. The program composer may guide the user through generation of a command. The program composer may detect a trigger word in a new command vocal input (e.g., a third vocal input) that indicates a new command is to be generated. In some embodiments, the program composer may provide a prompt to the user to provide a first vocal input.

The program composer may receive the first vocal input. The first vocal input may include conversational language (e.g., natural language) that describes at least a portion of the command. The program composer may determine a structure of the command based on the first vocal input. A template for the command may be generated based on the structure. The template may include a particular sequence of control command segments, functional command segments, and temporary result segments of the command.

The program composer may provide a prompt for a second vocal input. The program composer may receive the second vocal input that includes conversational language corresponding to at least one segment of the particular sequence. The program composer may assign one or more portions of the first vocal input and the second vocal input to corresponding segments of the particular sequence. Additionally, the program composer may generate an executable representation of the command. The executable representation may include the particular sequence of segments in a programming language that is executable by the voice assistant.

The program executor may receive additional vocal input (e.g., a fourth vocal input) that indicates that the voice assistant is to operate the command. Furthermore, the program executor may operate the command using the executable representation, which may cause the voice assistant to perform the control commands and the functional commands and store data related to the temporary results in the particular sequence.

This may permit voice assistants to be programmable using vocal input. This may also permit a user to use simple syntax to build new commands rather than requiring the user to be proficient at various programming languages. Additionally, the new commands may be generated by a user using a voice interface or a voice and a visual interface with little to no programming skills.

Embodiments of the present disclosure will be explained with reference to the accompanying drawings.

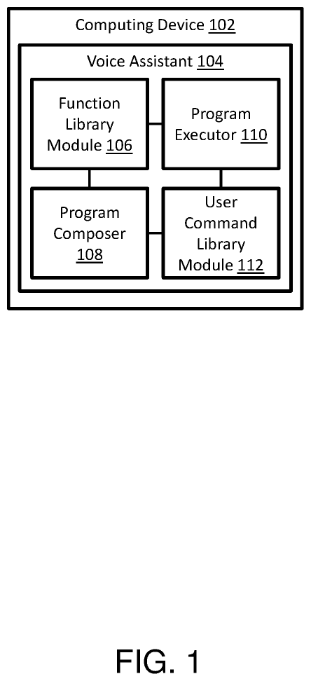

FIG. 1 is a block diagram of an example computing device 102 related to generating a command for a voice assistant 104 using vocal input, arranged in accordance with at least one embodiment described in the present disclosure. The computing device 102 may include a computer-based hardware device that includes a processor, memory, and communication capabilities. Some examples of the computing device 102 may include a mobile phone, a smartphone, a tablet computer, a laptop computer, a desktop computer, a set-top box, a virtual-reality device, or a connected device, etc. The computing device 102 may include a processor-based computing device. For example, the computing device 102 may include a hardware server or another processor-based computing device configured to function as a server. The computing device 102 may include memory and network communication capabilities.

The computing device 102 may include the voice assistant 104. In some embodiments, the voice assistant 104 may include a stand-alone application (“app”) that may be downloadable either directly from a host or from an application store or from the Internet. The voice assistant 104 may perform various operations relating to receiving vocal input and generating a command, as described in this disclosure. For example, the voice assistant 104 may include code and routines configured to generate the command based on vocal input. The voice assistant 104 may be configured to perform a series of operations with respect to vocal input that may be used to generate the command. For example, the voice assistant 104 may be configured to receive (e.g., obtain) vocal input including conversational language (e.g., natural speaking language) describing the command to be generated.

The voice assistant 104, for example, may be used to generate a command that reminds a user (e.g., at 8 AM) to bring an umbrella if the weather is expected to rain that day (referred to herein as “the umbrella example”). The voice assistant 104, as another example, may be used to generate a command that finds all bakeries in Sunnyvale Calif. that are gluten free and sort the results in a descending order (referred to herein as “the bakery example”).

The voice assistant 104 may include a function library module 106, a program composer 108, a program executor 110, and a user command library module 112. The function library module 106 may include multiple existing functions that are already supported by the voice assistant 104. The existing functions may include sort, filter, list, check weather, set reminder, count, or any other appropriate function that may be performed by the voice assistant 104. The existing functions may originate from a manufacturer of the voice assistant 104 or a third-party. The user command library module 112 may include commands that were previously generated by the voice assistant 104.

The program composer 108 and the program executor 110 may provide application programming interface (API) and/or software development kit (SDK) functionality to a user via the voice assistant 104. Additionally, the program composer 108 may be used to guide the user through a process for generating the command. Additionally, the program executor 110 may be used to parse the command and operate the command.

The program composer 108 may receive a new command vocal input (e.g., a third vocal input). The new command vocal input may include conversational language that includes a trigger term (e.g., a wake term). The new command vocal input may indicate that a command is to be generated for the voice assistant 104. The trigger term may include “new command,” “new program,” or any other appropriate term indicating a new program is to be generated.

The program composer 108 may provide a prompt to the user requesting a first vocal input. For example, the prompt may include “Create a new command. Go ahead” or any other appropriate prompt for requesting the first vocal input. The first vocal input may be received by the program composer 108. The first vocal input may include conversational language describing at least a portion of the command.

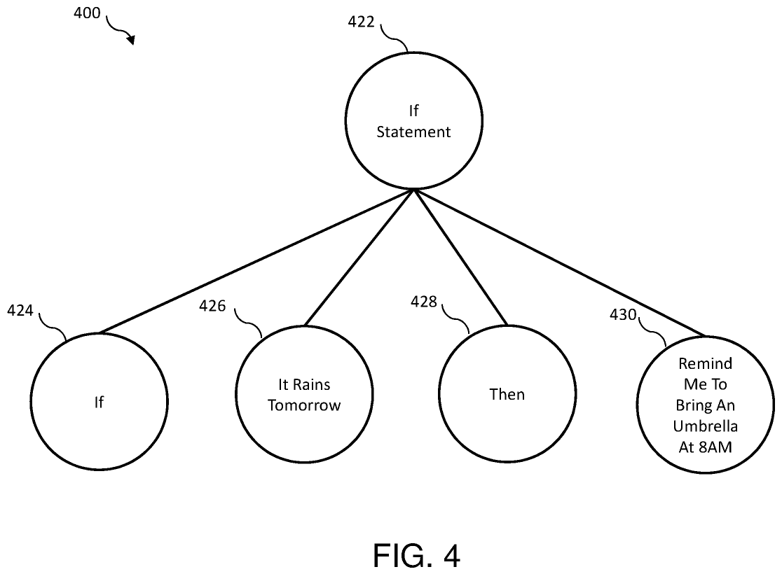

In some embodiments, the program composer 108 may convert the first vocal input to text representative of the first vocal input. The program composer 108 may parse the text representative of the first vocal input for syntax. For example, the program composer 108 may use a grammar model to determine syntax of the first vocal input. Additionally, the program composer 108 may generate a syntax tree which may separate different syntax portions of the first vocal input into different branches. A logical form of the first vocal input may be generated by the program composer 108. A logical form of vocal input is discussed in more detail below in relation to FIG. 4.

In the umbrella example, the first vocal input may include “If it rains tomorrow.” The program composer 108 may parse the first vocal input to include “If” and “it rains tomorrow” as separate syntax portions of the first vocal input. Additionally, in the bakery example, the first vocal input may include “First find all bakeries in Sunnyvale.” The program composer 108 may parse the first vocal input to include “First” and “find all bakeries in Sunnyvale” as separate syntax portions of the first vocal input.

The program composer 108 may determine a structure of the command based on the syntax portions of the first vocal input. The program composer 108 may compare one or more syntax portions in the first vocal input to known control commands. Control commands may indicate a flow of the command. Control commands may include if, then, and else; first, then, and finally; repeat and until; or any other appropriate control command for indicating flow of the command. In the umbrella example, the program composer 108 may determine that the first vocal input includes the control command of “If.” Additionally, in the bakery example, the program composer 108 may determine that the first vocal input includes the control command of “First.”

Additionally, the program composer 108 may compare remaining syntax portions of the first vocal input to known functional commands. In some embodiments, the functional commands may include the existing functions that are already supported by the voice assistant 104. Functional commands may include “set a reminder,” “check the weather,” “play music,” “check weather,” “sort (attribute, order),” “filter (keywords),” “list (count),” or any other appropriate functional command. In the umbrella example, the program composer 108 may determine that the first vocal input includes the functional command of “it rains tomorrow” (e.g., check weather tomorrow). Additionally, in the bakery example, the program composer 108 may determine that the first vocal input includes the functional command of “find all bakeries in Sunnyvale.”

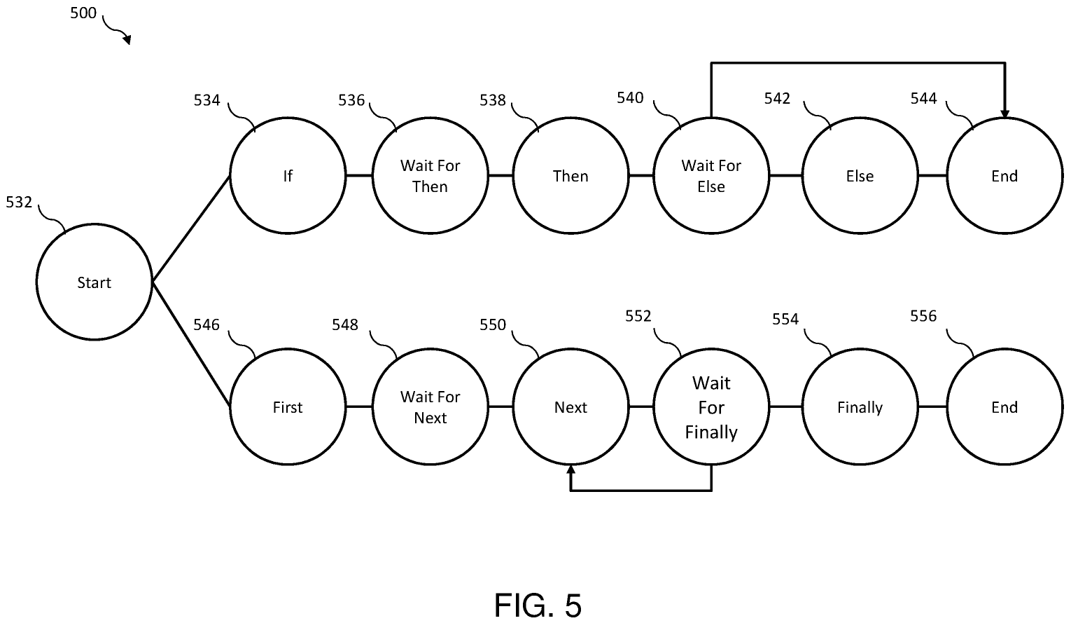

The program composer 108 may generate a template for the command. The template may be based on the structure. Additionally, the template may include a particular sequence of segments. In some embodiments, each of the segments may correspond to a control command, a functional command, or a temporary result of the command. In these and other embodiments, one or more of the segments may be used as a state machine (e.g., the segment may only be in one of a finite number of states). For example, a state of a functional command may either be true or false. Example templates are discussed in more detail below in relation to FIG. 5.

The program composer 108 may generate the template by determining portions of the command that correspond to the control commands, the functional commands, and/or the temporary results. In some embodiments, the temporary results may be used to represent data that is to be generated during operation of the command and may be internal to the voice assistant 104. The program composer 108 may assign the portions of the command that corresponds to control commands to one or more segments of the particular sequence that correspond to control commands. The program composer 108 may also assign the portions of the command that correspond to functional commands to one or more segments of the particular sequence that correspond to functional commands. Additionally, the program composer 108 may assign the portions of the command that correspond to temporary results to one or more segments of the particular sequence that also correspond to temporary results. The portions of the command that correspond to control commands, the functional commands, and the temporary results may be arranged in the particular sequence.

In the umbrella example, the program composer 108 may assign the control command of “If” to a corresponding segment in the particular sequence that corresponds to the control command of “If.” The program composer 108 may also assign the functional command of “it rains tomorrow” to a corresponding segment in the particular sequence that corresponds to a functional command connected to the control command of “If.” Additionally, in the bakery example, the program composer 108 may assign the control command of “First” to a corresponding segment in the particular sequence that corresponds to the control command of “First.” The program composer 108 may also assign the functional command of “find all bakeries in Sunnyvale” to a corresponding segment in the particular sequence that corresponds to a functional command connected to the control command of “First.”

In some embodiments, the program composer 108 may determine whether each segment in the particular sequence has a control command, a functional command, or a temporary result assigned to it. If one or more segments does not have a control command, a functional command, or a temporary result assigned to it, the program composer 108 may provide a prompt to the user for a second vocal input. The prompt for the second vocal input may include “Ok, what's next?” “Ok, (summary of the functional command), then what?” or any other appropriate prompt for the second vocal input. In these and other embodiments, the program composer 108 may indicate in the prompt which functions that are already supported by the voice assistant 104 may be compatible with the remaining segments. The program composer 108 may receive the second vocal input. The second vocal input may also include conversational language describing at least a portion of the command.

In some embodiments, the program composer 108 may convert the second vocal input to text representative of the second vocal input. The program composer 108 may parse the text representative of the second vocal input for syntax. Additionally, the program composer 108 may generate a syntax tree which may separate different syntax portions of the second vocal input into different branches. A logical form for the second vocal input may be generated by the program composer 108.

In the umbrella example, the second vocal input may include “Then remind me to bring an umbrella at 8 AM.” The program composer 108 may parse the second vocal input to include “Then” and “remind me to bring an umbrella at 8 AM” as separate syntax portions of the second vocal input. Additionally, in the bakery example, the second vocal input may include “Then filter gluten free.” The program composer 108 may parse the second vocal input to include “Then” and “filter gluten free” as separate syntax portions of the second vocal input.

The program composer 108 may assign the control commands and/or the functional commands included in the second vocal input to one or more remaining segments of the particular sequence based on whether the segments correspond to a control command or a functional command portion of the command. In the umbrella example, the program composer 108 may assign the control command of “Then” to a remaining segment in the particular sequence that corresponds to a control command. The program composer 108 may also assign the functional command of “remind me to bring an umbrella at 8 AM” to a remaining segment in the particular sequence that corresponds to a functional command. Additionally, in the bakery example, the program composer 108 may assign the control command of “Then” to a remaining segment in the particular sequence that corresponds to a control command. The program composer 108 may also assign the functional command of “filter gluten free” to a remaining segment in the particular sequence that corresponds to a functional command.

In some embodiments, the program composer 108 may determine whether each segment has a control command, a functional command, or a temporary result assigned to it. If one or more segments does not have a control command, a functional command, or a temporary result assigned to it, the program composer 108 may provide a prompt to the user for additional vocal input(s). The program composer 108 may repeat this process until each segment has a control command, a functional command, or a temporary result assigned to it.

In the bakery example, the program composer 108 may provide the prompt of “Ok, filter the result using keywords ‘gluten free.’ What's next?” A first additional vocal input may be received including “Next sort the result by rating in descending order.” The program composer 108 may provide the prompt “Ok, sort the filter result by rating in descending order. Then what?” A second additional vocal input may be received including “Finally list the result.” The program composer 108 may parse the first and second additional vocal inputs for control commands and functional commands and assign the control commands and functional commands to segments of the particular sequence. For example, the program composer 108 may parse the first and second additional vocal inputs and assign the control commands of “Next” and “Finally” to remaining segments in the particular sequence that correspond to control commands. Additionally, the program composer 108 may parse the first and second additional vocal inputs and assign the functional commands of “sort the result by rating in descending order” and “list the result” to remaining segments in the particular sequence that correspond to functional commands.

If each segment has a control command, a functional command, or a temporary result assigned to it, the program composer 108 may provide a summary of the command and provide a prompt to verify the command. In the umbrella example, the program composer 108 may provide the prompt of “Ok, then I will set a reminder to bring an umbrella at 8 AM. Is that all?”

If the command is correct, the program composer 108 may provide a prompt for a name of the command. The prompt may include “what's the name of the command?” The program composer 108 may receive a name vocal input that includes the name of the command. In the umbrella example, the name vocal input may include “Umbrella reminder.” Additionally, in the bakery example, the name vocal input may include “Gluten free bakery.”

The program composer 108 may generate an executable representation of the command. The executable representation may include the control commands, the functional commands, and the temporary results in the particular sequence in a programming language that is executable by the voice assistant 104. In the umbrella example, the executable representation may include “IF CheckWeather( )==Raining THEN SetReminder(‘Bring umbrella’, ‘8 am’).” The executable representation of the command may be stored in the user command library module 112.

The program composer 108 may provide a prompt indicating how to operate the command. The prompt may include “You can run the command by saying ‘run (the name of the command)’.” In the umbrella example, the prompt may include “You can run the command by saying ‘Run umbrella reminder’.” Additionally, in the bakery example, the prompt may include “You can run the command by saying ‘Run gluten free bakery’.”

If vocal input is received from the user indicating that the command is to be operated, the program executor 110 may access the command in the user command library module 112. The program executor 110 may operate the command using the executable representation. In the umbrella example, the program composer 108 may receive vocal input including “Run umbrella reminder.” Additionally, in the bakery example, the program composer 108 may receive vocal input including “Run gluten free bakery.” In response to these vocal inputs, the program executor 110 may operate the commands.

The program executor 110 may parse the command segment by segment of the particular sequence. In some embodiments, each control command, functional command, and/or temporary result may be operated or collected during operation.

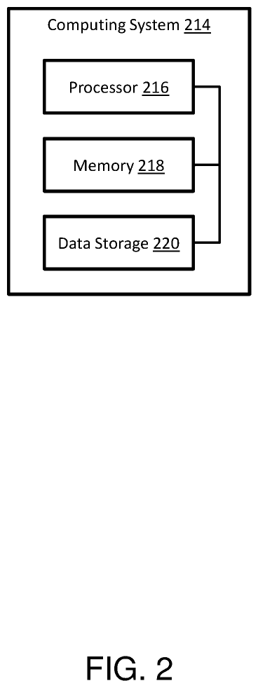

FIG. 2 illustrates an example computing system 214 that may be configured to generate a command using vocal input, arranged in accordance with at least one embodiment described in the present disclosure. The computing system 214 may be configured to implement and/or direct one or more operations associated with a voice assistant (e.g., the voice assistant of FIG. 1), a function library module (e.g., the function library module 106 of FIG. 1), a program composer (e.g., the program composer 108 of FIG. 1), a program executor (e.g., the program executor 110 of FIG. 1), and/or a user command library module (e.g., the user command library module 112 of FIG. 1). The computing system 214 may include a processor 216, a memory 218, and a data storage 220. The processor 216, the memory 218, and the data storage 220 may be communicatively coupled, e.g., via a communication bus.

In general, the processor 216 may include any suitable special-purpose or general-purpose computer, computing entity, or processing device including various computer hardware or software modules and may be configured to execute instructions stored on any applicable computer-readable storage media. For example, the processor 216 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. Although illustrated as a single processor in FIG. 2, the processor 216 may include any number of processors configured to, individually or collectively, perform or direct performance of any number of operations described in the present disclosure. Additionally, one or more of the processors may be present on one or more different electronic devices, such as different servers.

In some embodiments, the processor 216 may be configured to interpret and/or execute program instructions and/or process data stored in the memory 218, the data storage 220, or the memory 218 and the data storage 220. In some embodiments, the processor 216 may fetch program instructions from the data storage 220 and load the program instructions in the memory 218. After the program instructions are loaded into memory 218, the processor 216 may execute the program instructions.

For example, in some embodiments, the voice assistant, the function library module, the program composer, the program executor, and/or the user command library module may be included in the data storage 220 as program instructions. The processor 216 may fetch the program instructions of the voice assistant, the function library module, the program composer, the program executor, and/or the user command library module from the data storage 220 and may load the program instructions of the voice assistant, the function library module, the program composer, the program executor, and/or the user command library module in the memory 218. After the program instructions of the voice assistant, the function library module, the program composer, the program executor, and/or the user command library module are loaded into the memory 218, the processor 216 may execute the program instructions such that the computing system may implement the operations associated with the voice assistant, the function library module, the program composer, the program executor, and/or the user command library module as directed by the instructions.

The memory 218 and the data storage 220 may include computer-readable storage media for carrying or having computer-executable instructions or data structures stored thereon. Such computer-readable storage media may include any available media that may be accessed by a general-purpose or special-purpose computer, such as the processor 216. By way of example such computer-readable storage media may include tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store particular program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 216 to perform a certain operation or group of operations.

Modifications, additions, or omissions may be made to the computing system 214 without departing from the scope of the present disclosure. For example, in some embodiments, the computing system 214 may include any number of other components that may not be explicitly illustrated or described.

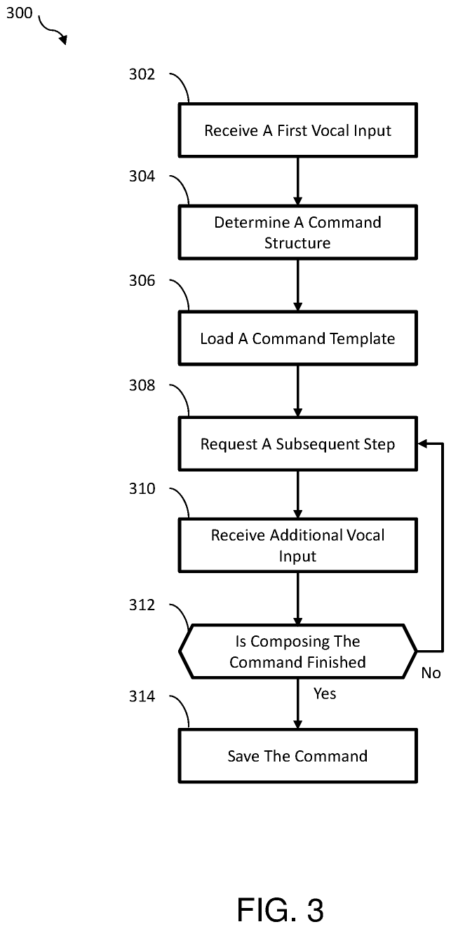

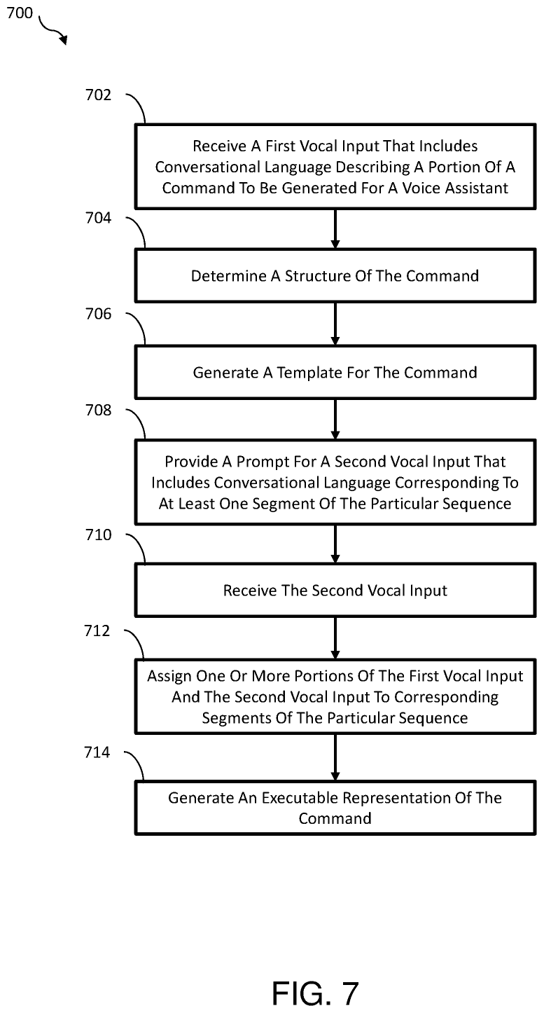

FIGS. 3 and 7 illustrate flow diagrams of example methods. The methods may be performed by processing logic that may include hardware (circuitry, dedicated logic, etc.), software (such as is run on a general purpose computer system or a dedicated machine), or a combination of both. The processing logic may be included in the computing device 102, the voice assistant 104, the function library module 106, the program composer 108, the program executor 110, and/or the user command library module 112 of FIG. 1, or another computer system or device. However, another system, or a combination of systems, may be used to perform the methods. For simplicity of explanation, methods described in the present disclosure are depicted and described as a series of acts. However, acts in accordance with this disclosure may occur in various orders and/or concurrently, and with other acts not presented and described in the present disclosure. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring of such methods to computing devices. The term article of manufacture, as used in the present disclosure, is intended to encompass a computer program accessible from any computer-readable device or storage media. Although illustrated as discrete blocks, various blocks may be divided into additional blocks, combined into fewer blocks, or eliminated, depending on the desired implementation.

FIG. 3 illustrates a flow diagram of an example method 300 related to generating a command using vocal input, in accordance with at least one embodiment described herein. The method 300 may begin at block 302 (“Receive A First Vocal Input”), where the processing logic may receive a first vocal input. The first vocal input may include conversational language describing at least a portion of a command to be generated. For example, in the umbrella example, a program composer (e.g., the program composer 108 of FIG. 1) may receive a first vocal input including “If it rains tomorrow.”

At block 304 (“Determine A Command Structure”), the processing logic may determine a command structure. The command structure may be determined based on control commands and/or functional commands that are included in the first vocal input. The processing logic may parse the first vocal input for syntax portions. Syntax portions may be compared to known control commands and/or functional commands. The command structure may be determined based on which known control commands and/or functional commands are included in the first vocal input. For example, in the umbrella example, the program composer may parse the first vocal input to include “If” and “it rains tomorrow” as separate syntax portions of the first vocal input and the program composer may determine the command structure is an “If Then” structure.

At block 306 (“Load A Command Template”), the processing logic may load a command template. The command template may be based on the command structure. Additionally, the command template may include a particular sequence of segments that correspond to a control command, a functional command, or a temporary result of the command. The processing logic may assign each of the control commands and/or the functional commands included in the first vocal input to a segment of the particular sequence. For example, in the umbrella example, the program composer may assign the “If” syntax portion to a control command segment and the “it rains tomorrow” syntax portion to a functional command segment.

At block 308 (“Request A Subsequent Step”), the processing logic may request a subsequent step. For example, the processing logic may provide a prompt to a user asking “What's next?”

At block 310 (“Receive Additional Vocal Input”), the processing logic may receive additional vocal input. The additional vocal input may also include conversational language describing at least a portion of the command to be generated. The processing logic may parse the additional vocal input for syntax portions. The processing logic may assign each of the control commands and/or the functional commands included in the additional vocal input to a segment of the particular sequence. For example, in the umbrella example, the program composer may receive a second vocal input that includes “Then remind me to bring an umbrella at 8 AM.” The program composer may parse and assign the control command of “Then” to a corresponding segment in the particular sequence. The program composer may also assign the functional command of “remind me to bring an umbrella at 8 AM” to a corresponding segment in the particular sequence.

At block 312 (“Is Composing The Command Finished”), the processing logic may determine whether composing the command is finished. The processing logic may determine whether each segment of the particular sequence has a control command, a functional command, or a temporary result assigned to it. If composing the command is finished (e.g., each segment of the particular sequence has a control command, a functional command, or a temporary result assigned to it), block 312 may be followed by block 314. If composing the command is not finished (e.g., each segment of the particular sequence does not have a control command, a functional command, or a temporary result assigned to it), block 312 may be followed by block 308. The processing logic may repeat blocks 308, 310, and 312 until composing the command is finished.

At block 314 (“Save The Command”), the processing logic may save the command. The command may be saved in a user command library module (e.g., the user command library module 112 of FIG. 1). For example, in the umbrella example, the umbrella reminder command may be saved to the user command library.

FIG. 4 illustrates an example logical form 400 of a parsed vocal input, which may be used for generating a command using the vocal input, arranged in accordance with at least one embodiment described in the present disclosure. The logical form 400 may be representative of vocal input received from a user. In some embodiments, the logical form 400 may correspond to a structure of the command. The logical form 400 may be generated by a program composer such as the program composer 108 of FIG. 1. The logical form 400 may relate to the umbrella example discussed above in relation to FIG. 1. The logical form 400 may be used by the program composer to generate a template of the command.

The logical form 400 may include a structure fragment 422. The logical form 400 may also include a first fragment 424, a second fragment 426, a third fragment 428, and a fourth fragment 430. Both the first fragment 424 and the third fragment 428 may correspond to a control command. For example, the first fragment 424 may include a control command of “If” and the third fragment 428 may include a control command of “Then.” Additionally, both the second fragment 426 and the fourth fragment 430 may correspond to a functional command. For example, the second fragment 426 may include a functional command of “It rains tomorrow” (e.g., check the weather for tomorrow). Likewise, the fourth fragment 430 may include a functional command of “Remind me to bring an umbrella at 8 AM” (e.g., set a reminder).

FIG. 5 illustrates an example flow diagram of a template 500, which may be used for generating a command using vocal input, arranged in accordance with at least one embodiment described in the present disclosure. The template 500 may be generated by a program composer such as the program composer 108 of FIG. 1. The template 500 may include a first template fragment 532, a second template fragment 534, a third template fragment 536, a fourth template fragment 538, a fifth template fragment 540, a sixth template fragment 542, a seventh template fragment 544, an eighth template fragment 546, a ninth template fragment 548, a tenth template fragment 550, an eleventh template fragment 552, a twelfth template fragment 554, and a thirteenth template fragment 556.

The template 500 may be representative of commands that may be generated. For example, the first template fragment 532, the second template fragment 534, the third template fragment 536, the fourth template fragment 538, the fifth template fragment 540, the sixth template fragment 542, and the seventh template fragment 544 may be representative of an “If Then” command. Additionally, the first template fragment 532, the eighth template fragment 546, the ninth template fragment 548, the tenth template fragment 550, the eleventh template fragment 552, the twelfth template fragment 554, and the thirteenth template fragment 556 may be representative of a “First, Next, and Finally” command.

At the first template fragment 532, the program composer may determine whether a first vocal input received from a user includes a control command that corresponds to the second template fragment 534 or the eighth template fragment 546. If the first vocal input includes the control command of “If,” the program composer may proceed to generate the command starting at the second template fragment 534. If the first vocal input includes the control command of “First,” the program composer may proceed to generate the command starting at the eighth template fragment 546.

At the second template fragment 534, the program composer may assign the control command included in the first vocal input to segments of a particular sequence corresponding to the control command. From the second template fragment 534, the program composer may proceed to the third template fragment 536.

At the third template fragment 536, the program composer may provide a prompt to the user for a second vocal input. The prompt for the second vocal input may be directed to receiving a functional command (e.g., a condition) of the command. For example, the prompt may include “Then what?” The program composer may wait at the third template fragment 536 until the second vocal input is received. The program composer may assign the control commands and/or functional commands included in the second vocal input to segments of the particular sequence corresponding to the control commands and/or the functional commands.

After receiving and assigning the second vocal input, the program composer may proceed to the fourth template fragment 538. At the fourth template fragment 538, the program composer may provide a list of compatible functional commands. The program composer may wait for additional input selecting a functional command from the list of compatible functional commands at the fourth template fragment 538. The program composer may assign the functional commands included in the additional input to segments of the particular sequence corresponding to the functional commands.

From the fourth template fragment 538, the program composer may proceed to the fifth template fragment 540. At the fifth template fragment 540, the program composer may provide a prompt for alternative input indicating an alternative functional command if the control command “If” doesn't occur. For example, in the umbrella example, the program composer may provide a prompt for a functional command to perform if it doesn't rain tomorrow. The program composer may wait at the fifth template fragment 540 until the alternative input indicating the alternative functional command if the control command “If” doesn't occur is received or until the alternative input is received indicating no alternative functional command is to be performed.

If input is received indicating no alternative functional command is to be performed, the program composer may proceed to the seventh template fragment 544 and end comprising the command. If input is received indicating an alternative functional command is to be performed, the program composer may proceed to the sixth template fragment 542. At the sixth template fragment 542, the program composer may assign the alternative functional command included in the alternative input to a segment of the particular sequence corresponding to the alternative functional command. The program composer may proceed to the seventh template fragment 544 and may end comprising the command.

At the eighth template fragment 546, the program composer may assign the control command included in the first vocal input to segments of the particular sequence corresponding to the control command. From the eighth template fragment 546, the program composer may proceed to the ninth template fragment 548. At the ninth template fragment 548, the program composer may provide a prompt to the user for the second vocal input. The prompt for the second vocal input may be directed to receiving a functional command (e.g., a condition) of the command. For example, the prompt may include “What's next?” The program composer may wait at the ninth template fragment 548 until the second vocal input is received. The program composer may assign the control commands and/or functional commands included in the second vocal input to segments of the particular sequence corresponding to the control commands and/or the functional commands.

After receiving the second vocal input, the program composer may proceed to the tenth template fragment 550. At the tenth template fragment 550, the program composer may provide a list of compatible functional commands. The program composer may wait for additional input selecting a functional command from the list of compatible functional commands at the tenth template fragment 550. The program composer may assign the functional commands included in the additional input to segments of the particular sequence corresponding to the functional commands.

From the tenth template fragment 550, the program composer may proceed to the eleventh template fragment 552. At the eleventh template fragment 552, the program composer may provide a prompt for additional vocal input indicating a functional command to be performed for the next control command. For example, in the bakery example, the program composer may provide a prompt for a functional command to perform after finding all bakeries in Sunnyvale. If the vocal input includes a functional command to perform as a final step (e.g., control command “Finally”), the program composer may proceed to the twelfth template fragment 554. If the vocal input includes a functional command to perform as an intermediate step (e.g., control commands “Then” or “Next”), the program composer may assign any received functional commands to corresponding segments of the particular sequence. Additionally, the program composer may return to the tenth template fragment 550 and repeat the process of the tenth template fragment 550 and the eleventh template fragment 552 until a final step is received.

At the twelfth template fragment 554, the program composer may assign the final functional command. The program composer may proceed to the thirteenth template fragment 556 and may end comprising the command.

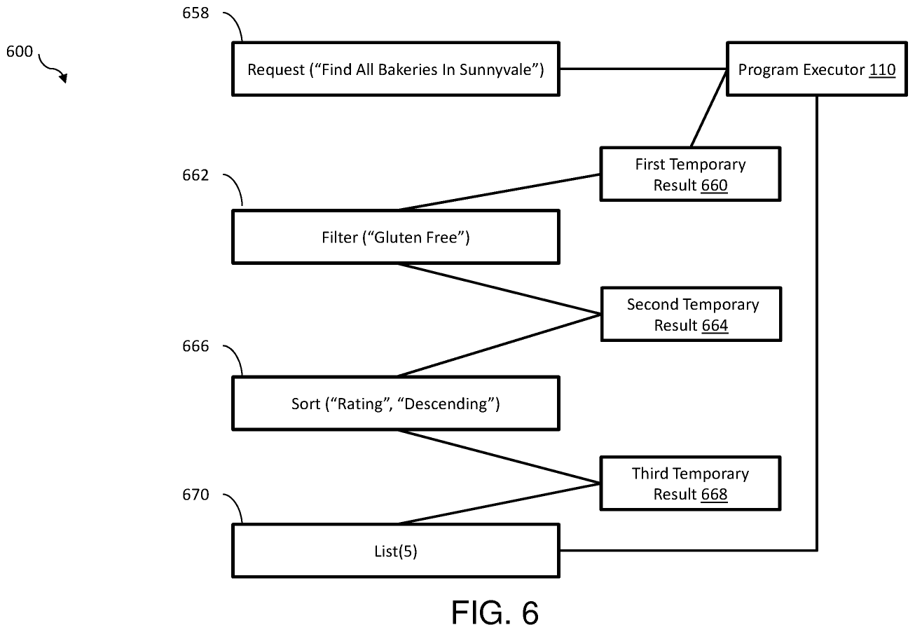

FIG. 6 illustrates a flow diagram 600 of an example operation of a previously generated command using vocal input, in accordance with at least one embodiments described in the present disclosure. The command may be operated by a program executor such as the program executor 110 of FIG. 1. The command may start at block 658, at which the functional command “Request (‘Find All Bakeries In Sunnyvale’)” may be provided to the program executor 110. The program executor 110 may find all bakeries in Sunnyvale using any appropriate functional command that is compatible with a voice assistant such as the voice assistant 104 of FIG. 1. The program executor 110 may generate the results of finding all bakeries in Sunnyvale as the first temporary result 660.

The command may proceed to block 662, at which the functional command “Filter (‘Gluten Free’)” may be applied to the first temporary result 660. The program executor 110 may filter out any bakeries that do not include the keywords “Gluten Free” in the first temporary result 660 using any appropriate functional command that is compatible with the voice assistant. The program executor 110 may generate the results of filtering out the bakeries that do not include the keywords “Gluten Free” in the first temporary result 660 as a second temporary result 664.

The command may proceed to block 666, at which the functional command “Sort (‘Rating’, ‘Descending’)” may be applied to the second temporary result 664. The program executor 110 may sort all the bakeries included in the second temporary result 664 using any appropriate functional command that is compatible with the voice assistant. The program executor 110 may generate the result of the sorting of the bakeries included in the second temporary result 664 as a third temporary result 668.

The command may proceed to block 670, at which the functional command “List(5)” may be applied to the third temporary result 668. The program executor 110 may list via a display or vocal output all of the bakeries included in the third temporary result 668 in descending order.

FIG. 7 illustrates a flow diagram of an example method 700 related to generating a command using vocal input, in accordance with at least one embodiment described herein. The method 700 may begin at block 702 (“Receive A First Vocal Input That Includes Conversational Language Describing A Portion Of A Command To Be Generated For A Voice Assistant”), where the processing logic may receive a first vocal input that includes conversational language describing a portion of a command to be generated for a voice assistant. For example, in the umbrella example, a program composer (e.g., the program composer 108 of FIG. 1) may receive a first vocal input including “If it rains tomorrow.”

At block 704 (“Determine A Structure Of The Command”), the processing logic may determine a structure of the command. The structure of the command may be determined based on the first vocal input. For example, the structure of the command may be determined based on control commands and/or functional commands that are included in the first vocal input. The processing logic may parse the first vocal input for syntax portions. Syntax portions may be compared to known control commands and/or functional commands. The structure of the command may be determined based on which known control commands and/or functional commands are included in the first vocal input. For example, in the umbrella example, the program composer may parse the first vocal input to include “If” and “it rains tomorrow” as separate syntax portions and the program composer may determine the structure of the command is an “If Then” structure.

At block 706 (“Generate A Template For The Command”), the processing logic may generate a template for the command. The template may be based on the structure of the command. Additionally, the template may include a particular sequence of segments that correspond to a control command, a functional command, or a temporary result of the command.

At block 708 (“Provide A Prompt For A Second Vocal Input That Includes Conversational Language Corresponding To At Least One Segment Of The Particular Sequence”), the processing logic may provide a prompt for a second vocal input that includes conversational language corresponding to at least one segment of the particular sequence. For example, the processing logic may provide a prompt to a user asking “What's next?”

At block 710 (“Receive The Second Vocal Input”), the processing logic may receive the second vocal input. The second vocal input may also include conversational language describing at least a portion of the command to be generated.

At block 712 (“Assign One Or More Portions Of The First Vocal Input And The Second Vocal Input To Corresponding Segments Of The Particular Sequence”), the processing logic may assign one or more portions of the first vocal input and the second vocal input to corresponding segments of the particular sequence. The processing logic may assign each of the control commands and/or the functional commands included in the first vocal input to a segment of the particular sequence. For example, in the umbrella example, the program composer may assign the “If” syntax portion to a control command segment and the “it rains tomorrow” syntax portion to a functional command segment. Additionally, the processing logic may assign each of the control commands and/or the functional commands included in the second vocal input to a segment of the particular sequence. For example, in the umbrella example, the program composer may receive the second vocal input that includes “Then remind me to bring an umbrella at 8 AM.” The program composer may parse and assign the control command of “Then” to a corresponding segment in the particular sequence. The program composer may also assign the functional command of “remind me to bring an umbrella at 8 AM” to a corresponding segment in the particular sequence.

At block 714 (“Generate An Executable Representation Of The Command”), the processing logic may generate an executable representation of the command. The executable representation may include the particular sequence of segments in a programming language that is executable by a voice assistant.

As indicated above, the embodiments described in the present disclosure may include the use of a special purpose or general purpose computer (e.g., the processor 216 of FIG. 2) including various computer hardware or software modules, as discussed in greater detail below. Further, as indicated above, embodiments described in the present disclosure may be implemented using computer-readable media (e.g., the memory 218 of FIG. 2) for carrying or having computer-executable instructions or data structures stored thereon.

As used in the present disclosure, the terms “module” or “component” may refer to specific hardware implementations configured to perform the actions of the module or component and/or software objects or software routines that may be stored on and/or executed by general purpose hardware (e.g., computer-readable media, processing devices, etc.) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated. In this description, a “computing entity” may be any computing system as previously defined in the present disclosure, or any module or combination of modulates running on a computing system.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure.

What is claimed is:

1. A method, comprising:
receiving a first vocal input that includes conversational language describing a portion of a command to be generated for a voice assistant;
determining a structure of the command based on the first vocal input;
generating a template for the command based on the structure, the template including a particular sequence of segments;
providing a prompt for a second vocal input that includes conversational language corresponding to at least one segment of the particular sequence;
receiving the second vocal input;
assigning one or more portions of the first vocal input and the second vocal input to corresponding segments of the particular sequence; and
generating an executable representation of the command, the executable representation including the particular sequence of segments.

2. The method of claim 1, further comprising receiving a third vocal input that includes a trigger term that indicates that the command is to be generated for the voice assistant using conversational language.

3. The method of claim 1, wherein generating the template for the command based on the structure, comprises:
determining one or more control commands of the command;
determining one or more functional commands of the command; and
determining one or more temporary results of the command.

4. The method of claim 3, wherein generating the template for the command based on the structure, comprises:
assigning the one or more control commands to one or more segments of the particular sequence;
assigning the one or more functional commands to one or more segments of the particular sequence; and
assigning the one or more temporary results to one or more segments of the particular sequence, wherein the one or more control commands, the one or more functional commands, and the one or more temporary results are arranged in the particular sequence.

5. The method of claim 4, wherein assigning one or more portions of the first vocal input and the second vocal input to corresponding segments of the particular sequence comprises:
determining whether each segment of the particular sequence includes at least a portion of at least one of the first vocal input and the second vocal input or a temporary result; and
in response to one or more segments not including at least a portion of at least one of the first vocal input and the second vocal input or a temporary result, request additional vocal input describing one or more portions of the command to be assigned to the one or more segments not including at least a portion of at least one of the first vocal input and the second vocal input or a temporary result.

6. The method of claim 1, the method further comprising:
receiving a fourth vocal input indicating that the voice assistant is to operate the command; and
operating the command using the executable representation, the voice assistant performing the command in the particular sequence.

7. The method of claim 1, wherein the command includes a plurality of existing functional commands that are already supported by the voice assistant arranged in the particular sequence.

8. A non-transitory computer-readable medium having computer-readable instructions stored thereon that are executable by a processor to perform or control performance of operations comprising:
receiving a first vocal input that includes conversational language describing a portion of a command to be generated for a voice assistant;
determining a structure of the command based on the first vocal input;
generating a template for the command based on the structure, the template including a particular sequence of segments;
providing a prompt for a second vocal input that includes conversational language corresponding to at least one segment of the particular sequence;
receiving the second vocal input;
assigning one or more portions of the first vocal input and the second vocal input to corresponding segments of the particular sequence; and
generating an executable representation of the command, the executable representation including the particular sequence of segments.

9. The non-transitory computer-readable medium of claim 8, the computer-readable instructions further comprising receiving a third vocal input that includes a trigger term that indicates that the command is to be generated for the voice assistant using conversational language.

10. The non-transitory computer-readable medium of claim 8, wherein the computer-readable instruction generating the template for the command based on the structure, comprises:
determining one or more control commands of the command;
determining one or more functional commands of the command; and
determining one or more temporary results of the command.

11. The non-transitory computer-readable medium of claim 10, wherein the computer-readable instruction generating the template for the command based on the structure, further comprises:
assigning the one or more control commands to one or more segments of the particular sequence;
assigning the one or more functional commands to one or more segments of the particular sequence; and
assigning the one or more temporary results to one or more segments of the particular sequence, wherein the one or more control commands, the one or more functional commands, and the one or more temporary results are arranged in the particular sequence.

12. The non-transitory computer-readable medium of claim 11, wherein the computer-readable instruction assigning one or more portions of the first vocal input and the second vocal input to corresponding segments of the particular sequence comprises:
determining whether each segment of the particular sequence includes at least a portion of at least one of the first vocal input and the second vocal input or a temporary result; and
in response to one or more segments not including at least a portion of at least one of the first vocal input and the second vocal input or a temporary result, request additional vocal input describing one or more portions of the command to be assigned to the one or more segments not including at least a portion of at least one of the first vocal input and the second vocal input or a temporary result.

13. The non-transitory computer-readable medium of claim 11, wherein the computer-readable instruction further comprising:
receiving a fourth vocal input indicating that the voice assistant is to operate the command; and
operating the command using the executable representation, the voice assistant performing the command in the particular sequence.

14. The non-transitory computer-readable medium of claim 8, wherein the command includes a plurality of existing functional commands that are already supported by the voice assistant arranged in the particular sequence.

15. A system, comprising:
one or more computer-readable storage media having instructions stored thereon; and
one or more processors communicatively coupled to the one or more computer-readable storage media and configured to cause the system to perform operations in response to executing the instructions stored on the one or more computer-readable storage media, the instructions comprising:
receiving a first vocal input that includes conversational language describing a portion of a command to be generated for a voice assistant;
determining a structure of the command based on the first vocal input;
generating a template for the command based on the structure, the template including a particular sequence of segments;
providing a prompt for a second vocal input that includes conversational language corresponding to at least one segment of the particular sequence;
receiving the second vocal input;
assigning one or more portions of the first vocal input and the second vocal input to corresponding segments of the particular sequence; and
generating an executable representation of the command, the executable representation including the particular sequence of segments.

16. The system of claim 15, the instructions further comprising receiving a third vocal input that includes a trigger term that indicates that the command is to be generated for the voice assistant using conversational language.

17. The system of claim 15, wherein the instruction generating the template for the command based on the structure, comprises:
determining one or more control commands of the command;
determining one or more functional commands of the command; and
determining one or more temporary results of the command.

18. The system of claim 17, wherein the instruction generating the template for the command based on the structure, further comprises:
assigning the one or more control commands to one or more segments of the particular sequence;
assigning the one or more functional commands to one or more segments of the particular sequence; and
assigning the one or more temporary results to one or more segments of the particular sequence, wherein the one or more control commands, the one or more functional commands, and the one or more temporary results are arranged in the particular sequence.

19. The system of claim 18, wherein the instruction assigning one or more portions of the first vocal input and the second vocal input to corresponding segments of the particular sequence comprises:
determining whether each segment of the particular sequence includes at least a portion of at least one of the first vocal input and the second vocal input or a temporary result; and
in response to one or more segments not including at least a portion of at least one of the first vocal input and the second vocal input or a temporary result, request additional vocal input describing one or more portions of the command to be assigned to the one or more segments not including at least a portion of at least one of the first vocal input and the second vocal input or a temporary result.

20. The system of claim 18, wherein the instruction further comprising:
receiving a fourth vocal input indicating that the voice assistant is to operate the command; and
operating the command using the executable representation, the voice assistant performing the command in the particular sequence.
